(19) United States
(12) Patent Application Publication
(10) Pub. No.: US 2021/0352764 A1
(43) Pub. Date: Nov. 11, 2021

(54) PROVISIONING A SMART DEVICE IN AN EXISTING SECURE NETWORK WITHOUT USING A CLOUD SERVICE

(71) Applicant: ABL IP HOLDING, LLC, Conyers, GA (US)

(72) Inventors: Robert W. Hamlin, Monroe, CT (US); Ryan A. Zaveruha, Trumbull, CT (US)

(21) Appl. No.: 16/868,197

(22) Filed: May 6, 2020

(51) Int. Cl. H04W 84/18; H04W 12/06; H04L 29/06; H04W 4/80; H04L 29/08; H04W 76/15; H04W 8/00

(52) U.S. Cl. CPC H04W 84/18; H04W 12/06; H04L 63/08; H04W 8/005; H04L 69/322; H04W 76/15; H04W 4/80

(57) ABSTRACT

After the establishment of a mesh network (e.g., a Bluetooth mesh network), a smart device (not the original provisioner) may be provisioned to the mesh network by a node of the mesh network, which acts a provisioner. Network keys and other provisioning information may be provided to the smart device from the provisioner node using a standard mesh provisioning process implemented in reverse (i.e., from the node to the smart device). The reverse-implementation of the standard mesh provisioning process does not require cloud services, a sideband channel, or any custom interface service between the smart device and the mesh network. Other methods of provisioning a smart device to a mesh network are also provided, as are other aspects.

### FIELD

The invention relates generally to the provisioning of devices in a secure network and, more particularly, to provisioning a smart device in an existing secure network.

### BACKGROUND

A network of interconnected wireless devices, such as in a lighting control system, may be considered a secure network if wireless devices are allowed to join the network only after a provisioning or commissioning process is used to provide security keys to the joining device. A mesh network (such as, e.g., a Bluetooth mesh network) may be an example of a secure network.

Provisioning or commissioning (referred to hereinafter as “provisioning”) is a process of securely adding another device to the secure network. Typically, a smart device running an application thereon is the “provisioner,” which initially provisions all other devices to create the secure, wireless network. Provisioning involves the transfer of provisioning information and security “keys” from the smart device to the device being added to the secure network. The security keys enable the added device to communicate with all other devices in the secure network and, as such, the security keys should be safeguarded to prevent unauthorized access to the secure network.

In some situations, a secure network may already exist. For example, a wireless lighting control system may be installed in a building and configured as a secure network. A subsequent user (e.g., a building tenant or manager) may then want to add the user's smart device to the secure network in order to operate the lighting control system. The user's smart device is not, however, the original provisioner and does not have the security keys. In some known provisioning processes, the security keys and provisioning information may be received by the user's smart device via downloading from a cloud service, to which the security keys and provisioning information may have been uploaded from the secure network after its initial creation. Such uploading, downloading, and storing of security keys and provisioning information to, from, and within a cloud service, however, may expose the secure network to security risks. Accordingly, a need exists to more securely provision a smart device into an existing secure network.

### SUMMARY

According to one aspect, a method of provisioning a smart device to an established mesh network is provided. The method comprises the following: providing a mesh provisioning service from a node of the mesh network; connecting automatically the smart device to the mesh provisioning service; transmitting automatically a provisioning invite from the node to the smart device in response to the smart device connecting to the mesh provisioning service; providing automatically identifying information from the smart device to the node in response to the smart device receiving the provisioning invite; authenticating the smart device and the node to each other; and transmitting automatically provisioning information and a security key from the node to the smart device in response to successful authentication.

According to another aspect, a mesh network is provided. The mesh network comprises a plurality of lighting and lighting control devices wirelessly coupled to each other such that each device is operable to communicate with every other device, wherein at least one device comprises a wireless transceiver, a processor, and a memory. The memory is operable to store instructions executable on the processor to cause the processor to perform the following: provide a mesh provisioning service; transmit a provisioning invite to a smart device in response to the smart device connecting to the mesh provisioning service; receive identifying information from the smart device; authenticate the smart device; and transmit provisioning information and a security key to the smart device to join the smart device to the mesh network in response to successful authentication.

According to a further aspect, a method of provisioning a smart device to an established mesh network is provided. The method comprises the following: providing a proprietary GATT (Generic Attribute Profile) service at a node of the mesh network, the proprietary GATT service configured to perform a mesh provisioning service; connecting automatically the smart device to the proprietary GATT service of the node; transmitting automatically a provisioning invite from the node to the smart device in response to the smart device connecting to the proprietary GATT service; providing automatically identifying information from the smart device to the node in response to the smart device receiving the provisioning invite; authenticating the smart device and the node to each other; and transmitting provisioning information and a security key from the node to the smart device in response to successful authentication.

Still other aspects, features, and advantages of the methods and apparatus disclosed herein may be readily apparent from the following detailed description and illustration of a number of example embodiments and implementations, including the best mode contemplated for carrying out the invention. This disclosure may also be capable of other and different embodiments, and its several details may be modified in various respects, all without departing from the scope of the invention. For example, although described hereinafter with respect to mesh networks, this disclosure may be applicable to any secure network, mesh or otherwise, in which network devices are allowed to join only after a provisioning process that provides security keys to the joining device. Accordingly, this disclosure is intended to cover all modifications, equivalents, and alternatives falling within the scope of the appended claims (see further below).

### BRIEF DESCRIPTION OF DRAWINGS

The drawings, described below, are for illustrative purposes and are not necessarily drawn to scale. Accordingly, the drawings and descriptions are to be regarded as illustrative in nature, and not as restrictive. The drawings are not intended to limit the scope of the invention in any way.

FIG. 1 illustrates a simplified diagram of a portion of a mesh network and a smart device to be joined to the mesh network according to embodiments.

FIG. 2 illustrates a simplified block diagram of a device of a mesh network according to embodiments.

FIG. 3 illustrates a provisioning sequence according to embodiments.

FIG. 4 illustrates a flowchart of a method of provisioning a smart device to an established mesh network according to embodiments.

FIG. 5 illustrates another provisioning sequence according to embodiments.

### DETAILED DESCRIPTION

A mesh network (e.g., a Bluetooth mesh network) may be considered a secure network if it requires a provisioning process to securely add another device to the network. Such a mesh network may include a number of wirelessly interconnected devices wherein each device, referred to as a node, may be configured to wirelessly receive and transmit data. Moreover, each device may be configured to broadcast or relay data across the network to all other devices of the network within the wireless range of the device (e.g., within a radio frequency (RF) range). Those devices receiving the relayed data may, in turn, broadcast or relay the received data to all other devices within their wireless range. This communication technique may be referred to as flooding. The relayed data may only be processed by the device(s) to which the data is addressed. The result is that every device may communicate with every other device, regardless of whether one device is within wireless range of another device. Such a mesh network may be referred to as having a many-to-many topology.

A wireless lighting control system may be implemented as a secure mesh network, which in some embodiments may be a Bluetooth mesh network, and may be configured to securely provision a smart device to the already existing mesh network by having various devices of the mesh network (i.e., mesh nodes) configured to serve as a provisioner. Such a mesh node may provision a smart device over a proxy connection to the smart device advantageously using only existing standard GATT (Generic Attribute Profile) methods and mesh messages. In contrast to a typical provisioning process in which the smart device is the provisioner that initially creates the mesh network and provisions all other devices, methods and apparatus according to one or more embodiments employ a standard mesh provisioning service (e.g., a GATT service), but in the reverse direction—a mesh network node provisions the smart device.

Provisioning in accordance with one or more embodiments may occur by exchanging a series of messages known as provisioning PDUs (Protocol Data Units). The messages may cause a sequence of processes to be executed including an invitation sent from a node (i.e., the provisioner) of the mesh network to a smart device to be provisioned. The smart device may respond to the invitation with a description of its capabilities. Messages may then be exchanged to authenticate the smart device. Several authentication methods are possible, as described further below. Finally, the smart device may be issued a network address and the network key from the provisioner. All of the messages may be implemented via firmware in the provisioner.

Advantageously, the reverse-implementation of the standard mesh provisioning process does not require cloud services, a sideband channel, or any custom interface service between the smart device and the mesh network.

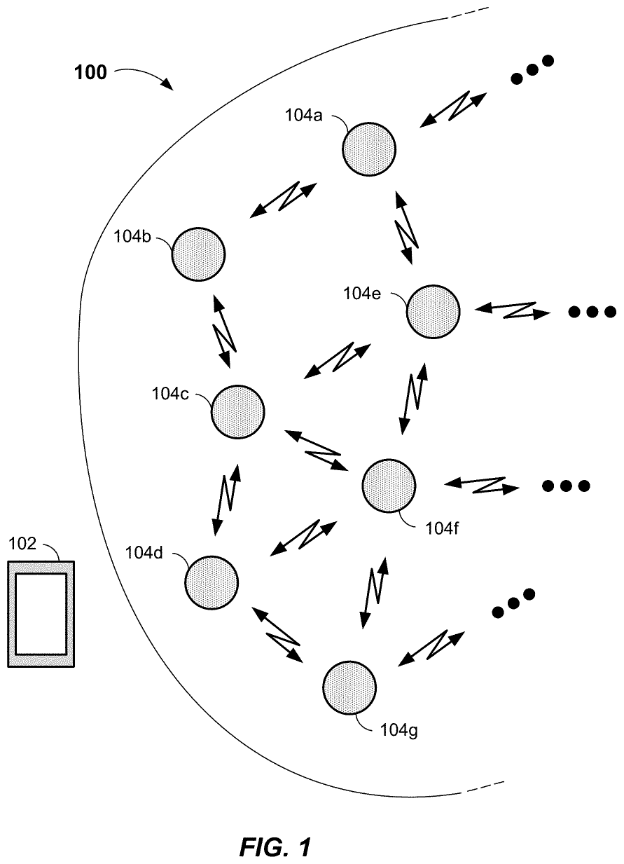

FIG. 1 illustrates a portion of an already established mesh network 100 and a smart device 102 to be joined to mesh network 100, which is a secure network, in accordance with one or more embodiments. In some embodiments, mesh network 100 may be a Bluetooth mesh network. Smart device 102 may be, e.g., a smartphone, a tablet, or similar device. Mesh network 100 may include a plurality of wireless devices (of which only devices 104a-g are shown). Each device may be, e.g., a Bluetooth device and may be part of, e.g., a lighting control system. As such, the devices may include light fixtures, light switches, occupancy sensors, daylight sensors, routers, relays, power distribution units, etc. The devices may also include other types of controllable devices, such as, alarms, thermostats, window shades, etc. Each device in mesh network 100 may be wirelessly connected to all other devices in mesh network 100 by employing a flooding communication technique. That is, mesh network 100 may be configured to have a many-to-many topology. In some embodiments, one or more devices may also employ point-to-point communication wherein one device may communicate directly with only one other device. Each device in mesh network 100 may be considered a node of mesh network 100. Note that in some embodiments, one or more devices may alternatively or additionally communicate via wired connections. Those devices without wireless communication capability would not be considered a node of the mesh network.

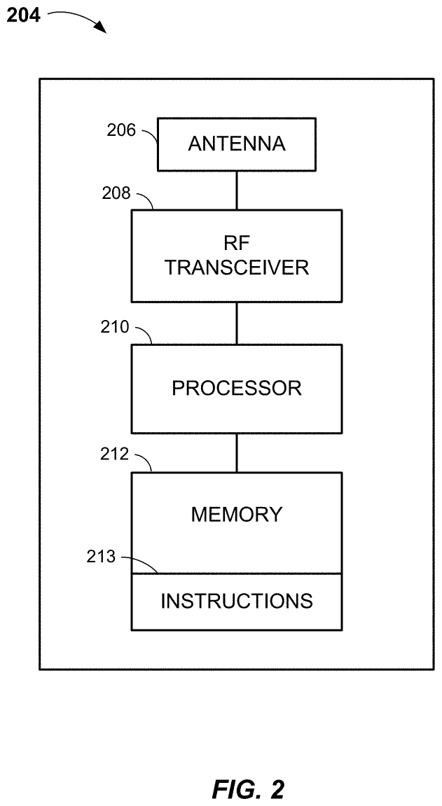

FIG. 2 illustrates a device 204 of mesh network 100 in accordance with one or more embodiments. Device 204 may be any one of devices 104a-g of FIG. 1 and may include an antenna 206, an RF (radio frequency) transceiver 208, a processor 210, and a memory 212 storing computer instructions 213 (e.g., application software and/or firmware) executable by processor 210, each interconnected via a suitable control and data bus system. Device 204 may include other components, circuits, and/or features in accordance with the function(s) of device 204 (e.g., light fixture, light switch, sensor, or other type of device in mesh network 100). RF transceiver 208 is configured to allow device 204 to wirelessly communicate with other devices of mesh network 100 within wireless range by receiving and transmitting signals via antenna 206. RF transceiver 208 may wirelessly communicate in accordance with, e.g., Bluetooth mesh networking. RF transceiver 208 may also be configured to wirelessly communicate with devices outside of mesh network 100, such as when serving as a provisioner, performing configuration and testing of device 204 (e.g., during manufacturing), and updating software and/or firmware stored in memory 212. Processor 210 may be, e.g., a microcontroller, a microprocessor, or other suitable computer processing component. Processor 210 is configured to execute computer programming instructions (such as computer instructions 213), process data, and communicate with other devices in mesh network 100 and outside of mesh network 100 (e.g., in connection with provisioning and/or updating software and/or firmware). Memory 212 may be non-volatile and, in addition to storing computer instructions 213 (e.g., software and firmware applications), may be configured to store an operating system and a database. Device 204 may be powered by an AC source (not shown) and may thus be considered a full-power node. Some devices of mesh network 100 may be battery powered and may thus be considered low power nodes. Low power nodes likely do not have sufficient power to serve as a provisioner. Thus, only full-power nodes, such as device 204, may be configured and capable of serving as a provisioner to, e.g., transform smart device 102 into a node of mesh network 100.

The provisioning process in accordance with one or more embodiments may begin by bringing smart device 102 within wireless range of a full-power node of mesh network 100, such as, e.g., device (node) 104d. In order for the smart device to communicate with mesh nodes, application software running on the smart device should send standard mesh messages. This may require the smart device to include a mesh bearer layer (which may be a basic Bluetooth bearer layer or other network bearer layer) implemented in its hardware, software, and/or firmware. The mesh bearer layer may be considered a low level of the mesh communication stack. However, smart devices without the capability of sending standard mesh messages may instead implement the client side of the mesh proxy service, which enables them to communicate with the mesh network via the provisioner serving as a proxy node.

Each full-power node, e.g., device 204, may advertise a mesh proxy service and optionally also a mesh provisioning service. A mesh provisioning service is a mesh GATT (Generic Attribute Profile) service implemented by a proxy node, which supports proxy protocol PDUs (Protocol Data Units) relating to provisioning. A mesh proxy service is also a mesh GATT service implemented by a proxy node, which supports those proxy protocol PDUs unrelated to provisioning.

In some embodiments, all full-power nodes may advertise by default upon power-up, and some may only advertise thereafter for a limited period of time, e.g., 5 minutes. After expiration of the initial advertising period, advertising may be re-enabled at a full-power node by, e.g., manually activating a pushbutton on the device, or using a smart device to issue an out-of-band (non-mesh) GATT command. In other embodiments, advertising may initially be disabled, thus requiring the advertising to be enabled as, e.g., described above, to initiate the provisioning process.

In still other embodiments, nodes may not advertise a mesh provisioning service (e.g., for security purposes). In those embodiments, a full-power node may provide an unadvertised mesh provisioning service upon power-up, and some may only provide the service thereafter for a limited period of time, e.g., 5 minutes. A full-power node may also or alternatively provide an unadvertised mesh provisioning service by, e.g., manually activating a pushbutton or pushbutton sequence on a device (node), or using a smart device to issue an out-of-band (non-mesh) GATT command.

A full-power node serving as a provisioner may become a proxy node in cases where the smart device does not support certain mesh protocols. The proxy capability may be implemented in all full-power nodes and initially may be enabled or disabled. In some embodiments, each full-power node may have the proxy capability enabled until a smart device disables it (e.g., after the smart device joins the mesh network and no longer needs the mesh proxy service). In other embodiments, the proxy capability may be enabled by a smart device via a standard mesh message, or by manually entering a pushbutton code into the device (node), or via firmware stored in the device (node) that can make pre-programmed decisions (e.g., enable proxy capability) based on initial communications between the provisioner and a smart device seeking to be provisioned. The proxy node implements a proxy protocol and acts as an intermediary between the smart device and the mesh network, thus allowing a non-mesh-supported BLE (Bluetooth Low Energy) device to communicate with a mesh network using standard mesh messages sent over the mesh proxy GATT service. GATT services may perform an interface function between, e.g., smart device 102 and a (proxy) node (e.g., device 104d) of mesh network 100 serving as a provisioner.

Smart device 102, within wireless range of the advertising node and running a standard mesh provisioning application, may detect either an advertised mesh provisioning service or advertised mesh proxy service and, in response, may connect to the mesh provisioning service. In other embodiments, smart device 102 may connect to an unadvertised mesh provisioning service in response to other conditions. For example, smart device 102 may connect to an unadvertised mesh provisioning service provided by a node in response to detection of another advertised service or advertised special identifier (e.g., a company identifier) by that node, or may connect to an unadvertised mesh provisioning service provided by a node within a limited period of time after a mesh network power-up or manual activation of the mesh provisioning service at that node.

The connection to the mesh provisioning service may occur automatically if the user indicates via the smart device that access to the mesh network is desired, or if the user attempts to configure or control a mesh node (e.g., a lighting device). In response to smart device 102 connecting to the mesh provisioning service hosted by a node (which now becomes the provisioner as a result of the connection), the node transmits a provisioning invite to smart device 102, wherein a standard (e.g., Bluetooth) provisioning process is followed. The provisioning process may include the following: smart device 102, in response to the smart device receiving the provisioning invite, may provide identifying information to the provisioner via a provisioning-capabilities PDU. The provisioner and smart device 102 may then exchange their public keys.

Authentication between the provisioner and smart device 102 may occur next. In some embodiments, authentication may proceed as follows for a first smart device to be provisioned in mesh network 100: A user may enter a pre-determined sequence of button presses on the device acting as the provisioner, which has the pre-determined sequence of button presses stored thereat in software or firmware. This security feature ensures the user has (1) physical access to the mesh network (i.e., is not attempting to gain unauthorized access remotely), and (2) knowledge of the pre-determined sequence of button presses. The user may next set a multi-digit code (e.g., a PIN (personal identification number)) by entering the multi-digit code into the smart device 102, wherein the code may be, e.g., 4-8 digits made up of any combination of, e.g., numbers, letters, and/or special characters. The multi-digit code is then transmitted in a secure manner to the provisioner and stored therein. Eventually the received multi-digit code is relayed to and stored in each of the other mesh node devices so that each may be capable of acting as a provisioner.

Authentication for subsequent smart devices to be provisioned in mesh network 100 may proceed as follows: a user of a subsequent smart device, who has obtained the multi-digit code from, e.g., the first user, may enter the multi-digit code into the smart device when prompted by the provisioner (which now has the multi-digit code stored therein from authentication of the first smart device). The entered multi-digit code is then transmitted in a secure manner from the subsequent smart device to the provisioner, which verifies that the received multi-digit code is correct.

In some embodiments, authentication may be accomplished with two or more multi-digit codes to establish two or more classes of users each with different levels of access or access privileges. For example, a primary multi-digit code may be used to give that class of user full control over all aspects of the devices in the mesh network. For example, in a lighting control system, such a primary user may be able to set and/or change lighting control settings, network device configuration, occupancy sensor time delays and sensitivities, default light levels, etc. A secondary multi-digit code, e.g., may give a secondary user limited access to only, e.g., control the on/off and dimming functions of certain lights in the lighting control system.

After successful completion of the authentication process, a session key may be derived by the provisioner and smart device 102 from their private keys and the exchanged public keys. The session key may then be used to secure transmission of provisioning information and a security key (e.g., a network key) from the provisioner to smart device 102 to complete the provisioning process. Upon completion of the provisioning process, smart device 102 may disconnect from the mesh provisioning service and connect to the mesh proxy service. The provisioner may then configure smart device 102 (e.g., provide application and device keys). Smart device 102 may now be joined to mesh network 100 and may be configured to communicate with and/or control the various devices in mesh network 100 using a mesh proxy GATT service. For example, smart device 102 may provision new devices, change node settings, and/or control various lighting functions.

Advantageously, the provisioning process of smart device 102 uses only standardized techniques in accordance with one or more embodiments, and may include one or more of the following features:
a mesh node may serve as a provisioner and may advertise and host a GATT connection as a GATT server;
the connection between the smart device and the provisioner may be encrypted to prevent an eavesdropper from harvesting any codes or security keys of the mesh network.
the mesh node may also act as a proxy server;
the proxy protocol may be used to exchange provisioning PDUs as allowed by the Bluetooth Mesh Profile standard;
the mesh provisioning service may be used to support provisioning PDUs (note that the mesh proxy service does not support provisioning PDUs);
all write characteristics may be implemented as “write with response,” which provides a low level acknowledge;
the provisioner may generate new device credentials and automatically add the smart device to the mesh network's configuration database;
a new device may only be generated once per connection; and
only a single element may be reserved for the smart device (an element is a controllable part of a node, e.g., an LED lighting fixture with three individually-controllable LEDs (light emitting diodes) would form a single node with three elements).

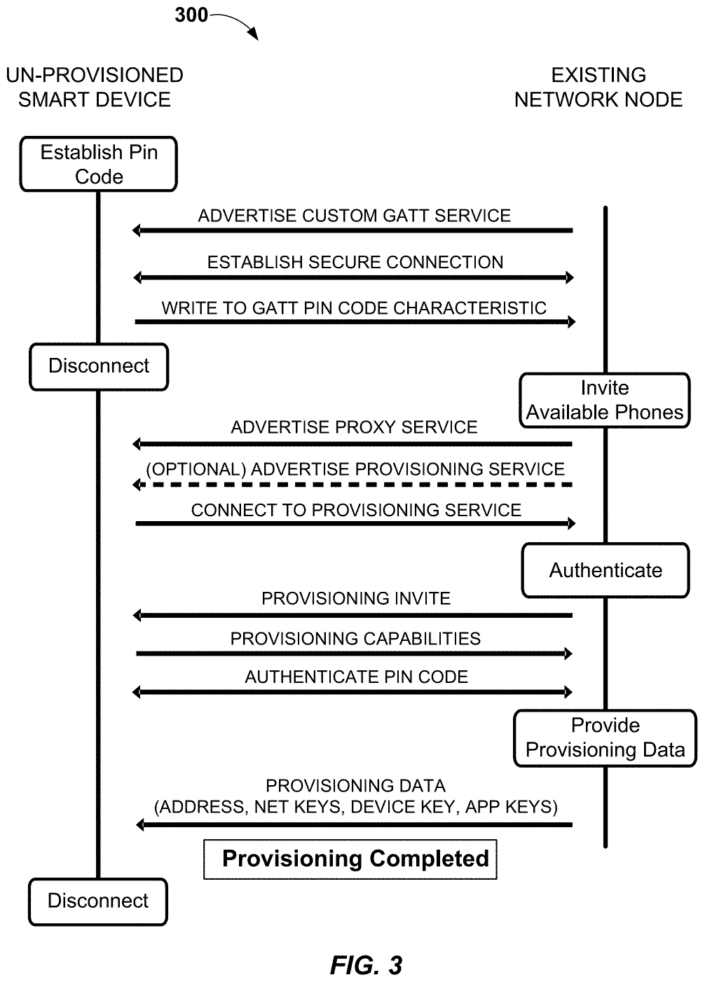

FIG. 3 illustrates an example provisioning sequence 300 in accordance with one or more embodiments. In provisioning sequence 300, an existing mesh node provisions a smart device using a mesh provisioning service. The “Establish Pin Code” process occurs only once, and may be performed by a different smart device than the smart device being provisioned.

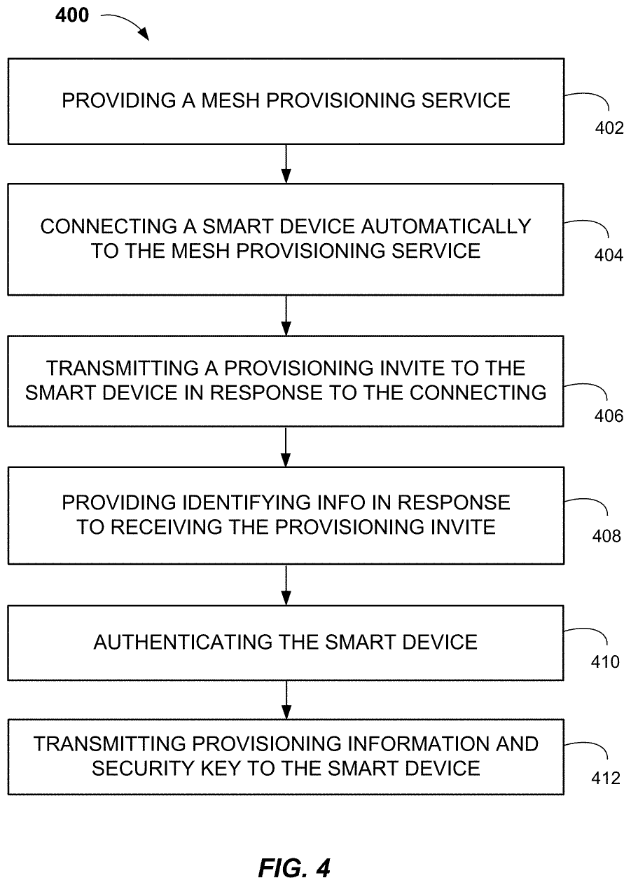

FIG. 4 illustrates a method 400 of provisioning a smart device to an established mesh network in accordance with one or more embodiments. The mesh network may be, e.g., a Bluetooth mesh network. At process block 402, method 400 may include providing a mesh provisioning service at a node of the mesh network. For example, as shown in FIG. 1, each of wireless devices 104a-g may be considered a mesh node, and any one or more of wireless devices 104a-g may provide a mesh provisioning service. The mesh provisioning service may optionally be advertised by one or more of the nodes along with advertising of a mesh proxy service by the one or more nodes. In some embodiments, the optional advertising of the mesh provisioning service may occur automatically upon power-up of the mesh network or upon manual activation at a node of the mesh network. In some embodiments, the advertising of the mesh provisioning service may occur only for a limited period of time after mesh network power-up and/or manual activation.

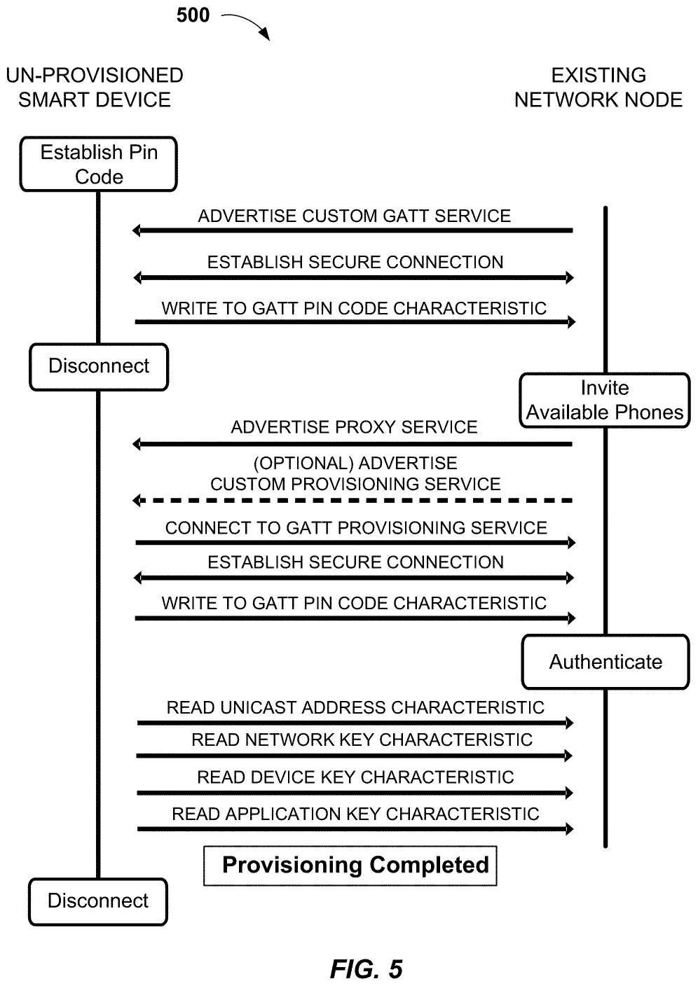

At process block 404, method 400 may include connecting a smart device automatically to the mesh provisioning service. That is, a smart device to be joined to the mesh network and within wireless range of a node of the mesh network may automatically connect to the mesh provisioning service in response to one of the following conditions according to one or more embodiments: (1) detection of an advertised mesh provisioning service; (2) detection of an advertised mesh proxy service in cases where the mesh provisioning service is not advertised; (3) detection of another advertised service or advertised special identifier (e.g., a company identifier); (4) within a limited period of time after mesh network power-up; or (5) within a limited period of time after manual activation of a mesh provisioning service at a node (e.g., one or more button presses at a device (node) of the mesh network). Other conditions may be possible. In response to any of the above conditions, the smart device may automatically connect to the mesh provisioning service. For example, referring to FIG. 1, smart device 102 may be within wireless range of device (node) 104d and may detect advertising by device (node) 104d. In response, smart device 102 may automatically connect to the mesh provisioning service of device (node) 104d. In some embodiments, the mesh provisioning service may be a standard (e.g., Bluetooth) mesh provisioning service. In other embodiments described further below and as shown in FIG. 5, the mesh provisioning service may be a custom or proprietary GATT service. The connection may, in some embodiments, be encrypted to prevent an eavesdropper from harvesting the multi-digit codes or any of the security keys.

At process block 406, method 400 may include automatically transmitting a provisioning invite from the node to the smart device in response to the smart device connecting to the mesh provisioning service. Continuing with the example above, device (node) 104d may automatically transmit a provisioning invite to smart device 102 in response to smart device 102 connecting to the mesh provisioning service hosted by device (node) 104d.

At process block 408, method 400 may include the smart device automatically providing identifying information to the node in response to receiving the provisioning invite. The identifying information may include, e.g., a description of the smart device's capabilities, and may be transmitted automatically from the smart device to the node via one or more provisioning PDUs.

At process block 410, method 400 may include authenticating the smart device and the node to each other. As described above, authentication may proceed differently depending on whether the smart device is the first smart device or a subsequent smart device to be provisioned to the mesh network. In either case, authentication may require the entering of a multi-digit code in the smart device for secure transmission to the node, either to establish the multi-digit code of the mesh network in the case of a first smart device to be provisioned, or to verify that the correct multi-digit code had been entered in the case of a subsequent smart device to be provisioned. As also described, more than one multi-digit code may be acceptable, depending on whether multiple levels of access privileges have been established. In some embodiments, if an incorrect multi-digit code is entered, the connection is terminated and the smart device will need to re-connect in order to be provisioned.

In response to the authentication process successfully completing, method 400 at process block 412 may include transmitting from the node to the smart device provisioning information including a security key (which may be referred to as a network key, which all nodes of the mesh network possess). The provisioning information may also include, e.g., a network address for the smart device, one or more application keys for decrypting data applicable to only certain nodes that have a common function or function as a group, and a device key, which is unique for each node. Upon completion of the provisioning process, the smart device becomes a node of the mesh network, and can be used to control and/or transmit information and/or data to and from other nodes of the mesh network.

Note that in some embodiments, method 400 or portions thereof may be implemented as a computer program product or software that may include a machine-readable medium having non-transient instructions stored thereon, which may be used to program a computer system, controller, or other electronic device to perform method 400 or portions thereof in accordance with one or more embodiments.

To improve security, a mesh node in some embodiments may host a proprietary GATT service instead of a standard mesh provisioning service. The proprietary GATT service may be configured to behave identically, or substantially identically, as the standard mesh provisioning service, but will have a different name. In some embodiments, this proprietary GATT service may be advertised. In other embodiments, the proprietary GATT service may not be advertised. If it is not advertised, devices may be configured (i.e., pre-programmed via, e.g., firmware) to recognize certain devices (nodes) (e.g., those manufactured by a particular company) and to detect the advertising of a mesh proxy service by those devices. In response to recognition and detection of one of those devices and its advertised mesh proxy service, the smart device may automatically connect to the unadvertised proprietary GATT service hosted by that device in order to be provisioned. This improves security by preventing “generic” smart devices that are searching for advertised mesh provisioning services from attempting to join the mesh network. Provisioning over a proprietary GATT service may still require entry of the correct multi-digit code in order to receive provisioning information (including the security key) from the provisioner.

In still other embodiments, once a smart device is connected to a special provisioning service (e.g., a proprietary GATT service), network and device keys may possibly be transferred using proprietary messages rather than the same provisioning PDUs defined in the SIG (Special Interest Group) Mesh standard. As long as the required information is transferred to the smart device, it will have the effect of provisioning that smart device.

FIG. 5 illustrates a provisioning sequence 500 in accordance with one or more embodiments. In provisioning sequence 500, an existing mesh node provisions a smart device using a custom provisioning (GATT) service as described above.

In some embodiments, each device (e.g., a lighting control device, light switch, light fixture, etc.) may have via software/firmware the capability of creating a network. This allows such enhanced devices to create a mesh or other type of secure network themselves without using a smart device to control the process. This may be referred to as “app-less provisioning.” These same enhanced devices may be used with a smart device to create a new network, but without requiring the smart device to have the capability of creating a network, as is conventional. Normally, when a smart device establishes a mesh or other type of secure network and provisions the nodes, the smart device has software/firmware providing it with the capability to create a new network and provision each node. This capability enables the smart device to generate a network key, use that key to provision itself (assign itself a network address and generate its own device key which is derived from the network key), and then provision the other devices to form the mesh or other type of secure network. Rather than provide that capability to the smart device, a proprietary GATT service in accordance with one or more embodiments may instead have the smart device instruct an enhanced device to create a new network. Once the enhanced device has done that, it may then provision the smart device over the same proprietary GATT service. This advantageously avoids having to unnecessarily replicate the “create a new network” capability in a smart device.

While the disclosure is susceptible to various modifications and alternative forms, specific method and apparatus embodiments have been shown by way of example in the drawings and are described in detail herein. It should be understood, however, that the particular methods and apparatus disclosed herein are not intended to limit the disclosure but, to the contrary, to cover all modifications, equivalents, and alternatives falling within the scope of the claims.

1. A method of provisioning a smart device to an established mesh network, the method comprising:
providing a mesh provisioning service via a node of the mesh network;
connecting automatically the smart device to the mesh provisioning service in response to the smart device detecting the mesh provisioning service or a special identifier of the node;
transmitting automatically a provisioning invite from the node to the smart device in response to the smart device connecting to the mesh provisioning service;
providing automatically identifying information from the smart device to the node in response to the smart device receiving the provisioning invite;
authenticating the smart device and the node to each other; and
transmitting automatically provisioning information and a security key from the node to the smart device in response to successful authentication.

2. The method of claim 1 wherein:
the providing the mesh provisioning service comprises advertising the mesh provisioning service; and
the connecting automatically the smart device to the mesh provisioning service comprises connecting automatically the smart device to the mesh provisioning service in response to the smart device receiving the advertising.

3. The method of claim 1 wherein the providing the mesh provisioning service begins automatically upon power-up of the mesh network or upon a manual activation at the node.

4. The method of claim 1 wherein the providing identifying information comprises providing a provisioning-capabilities PDU (protocol data unit).

5. The method of claim 1 wherein the authenticating comprises:
entering a pre-determined sequence of button presses at the node, the node comprising a wireless device of the mesh network and having at least one manually pressable button; and
entering a multi-digit code into the smart device to be transmitted to and stored at the node;
wherein the smart device is the first smart device to be provisioned to the mesh network.

6. The method of claim 1 wherein the authenticating comprises:
entering a pre-determined multi-digit code into the smart device to be verified by the node;
wherein the smart device is not the first smart device to be provisioned to the established mesh network.

7. The method of claim 1 wherein the authenticating comprises:
entering one of a plurality of pre-determined multi-digit codes into the smart device to be verified by the node, wherein each of the pre-determined multi-digit codes provides a different level of access to the mesh network;
wherein the smart device is not the first smart device to be provisioned to the established mesh network.

8. The method of claim 1 wherein the node of the mesh network hosts a GATT (Generic Attribute Profile) connection as a GATT server.

9. The method of claim 1 wherein the mesh network is a Bluetooth mesh network.

10. A mesh network, comprising:
a plurality of lighting and lighting control devices wirelessly coupled to each other such that each device is operable to communicate with every other device, wherein at least one device comprises a wireless transceiver, a processor, and a memory, the memory storing instructions executable on the processor to cause the processor to:
provide a mesh provisioning service;
connect a smart device to the mesh provisioning service in response to the smart device detecting the mesh provisioning service or a special identifier of the at least one device;
transmit a provisioning invite to the smart device in response to the smart device connecting to the mesh provisioning service;
receive identifying information from the smart device;
authenticate the smart device; and
transmit provisioning information and a security key to the smart device to join the smart device to the mesh network in response to successful authentication.

11. The mesh network of claim 10 wherein the processor advertises the mesh provisioning service automatically upon power-up of the mesh network or advertises the mesh provisioning service upon a manual activation at the at least one device.

12. The mesh network of claim 10 wherein the processor authenticates the smart device by verifying one of a plurality of pre-determined multi-digit codes entered into the smart device, each of the pre-determined multi-digit codes providing a different level of access to the mesh network.

13. The mesh network of claim 10 wherein the mesh network is a Bluetooth mesh network.

14. The mesh network of claim 10 wherein the identifying information is comprised in a provisioning-capabilities PDU (protocol data units).

15. The mesh network of claim 10 wherein the at least one device of the mesh network hosts a GATT (Generic Attribute Profile) connection as a GATT server.

16. The mesh network of claim 10 wherein the mesh network comprises a plurality of lighting and light control devices.

17. A method of provisioning a smart device to an established mesh network, the method comprising:
providing a proprietary GATT (Generic Attribute Profile) service at a node of the mesh network, the proprietary GATT service configured to perform a mesh provisioning service;
connecting automatically the smart device to the proprietary GATT service of the node in response to the smart device recognizing the node providing the proprietary GATT service;
transmitting automatically a provisioning invite from the node to the smart device in response to the smart device connecting to the proprietary GATT service;
providing automatically identifying information from the smart device to the node in response to the smart device receiving the provisioning invite;
authenticating the smart device and the node to each other; and
transmitting provisioning information and a security key from the node to the smart device in response to successful authentication.

18. The method of claim 17 wherein the smart device is pre-programmed to recognize the node as having the proprietary GATT service.

19. The method of claim 17 wherein the authenticating comprises entering one of a plurality of pre-determined multi-digit codes into the smart device to be verified by the node, wherein each of the pre-determined multi-digit codes provides a different level of access to the mesh network.

20. The method of claim 17 wherein the transmitting provisioning information and a security key comprises transmitting automatically provisioning information and a security key via provisioning PDUs (protocol data units) or proprietary messages.
